(19) United States
(12) Patent Application Publication
(10) Pub. No.: US 2026/0276861 A1
(43) Pub. Date: Sep. 17, 2026

(54) SYSTEM AND METHOD OF SIMULATING SEISMIC WAVE PROPAGATION

(71) Applicant: Shearwater GeoServices Software Inc., Houston, TX (US)

(72) Inventors: Rodrigo Fuck, Houston, TX (US); Lorenzo Casasanta, Houston, TX (US)

(21) Appl. No.: 19/079,968

(22) Filed: Mar. 14, 2025

(51) Int. Cl. G01V 20/00

(52) U.S. Cl. CPC G01V 20/00

(57) ABSTRACT

A method of simulating seismic wave propagation in media, the method implemented by a computer comprising a processor and a memory, the method comprising: modelling, using an earth model having a grid, a medium as a set of elastic tensors, wherein respective elastic tensors of the set thereof have tilted orientations relative to the grid; and simulating seismic wave propagation in the medium using a wave-equation operator, wherein the wave-equation operator is invariant to orientation changes of the respective elastic tensors of the set thereof.

### FIELD

The present disclosure relates to systems and methods of simulating seismic wave propagation, for example, for depth-imaging and inversion of earth model parameters using seismic data in the context of oil and gas (hydrocarbon) exploration.

### BACKGROUND

As hydrocarbon exploration and production move into more remote, deeper, and challenging geological settings, there is a growing demand for better and more reliable numerical algorithms to produce the necessary images and earth models.

The trend in both depth-imaging and inversion of seismic data over the past few decades has been the inclusion of more physical wave phenomena to match the growing complexity of the earth models. Among these is the increased use of anisotropy of the physical medium in which the seismic wave field propagates to improve the match between real input data and data simulations. Currently, the most cutting-edge numerical simulations of seismic wave propagation assume that the underlying earth models are composed of sedimentary rocks that can be described by elastic tensors with Tilted Transverse Isotropy (TTI) or Tilted Orthorhombic (TORT) symmetries, both often observed throughout the geologic sections of hydrocarbon-bearing basins and plays. Despite the many advances over the last 20 years in the accuracy of simulating seismic wave, the wave-equation operators used in these simulations still suffer from numerical instabilities. Addressing this issue is crucial for the success of seismic imaging and inversion in complex geological settings and thus to the success of hydrocarbon exploration and production.

Hence, there is a need to improve methods of simulating seismic wave propagation.

### SUMMARY

A first aspect provides a method of simulating seismic wave propagation in media, the method implemented by a computer comprising a processor and a memory, the method comprising: modelling, using an earth model having a grid, a medium as a set of elastic tensors, wherein respective elastic tensors of the set thereof have tilted orientations relative to the grid; and simulating seismic wave propagation in the medium using a wave-equation operator, wherein the wave-equation operator is invariant to orientation changes of the respective elastic tensors of the set thereof.

A second aspect provides a method of simulating wave propagation in media, the method implemented by a computer comprising a processor and a memory, the method comprising: modelling, using a model having a grid, a medium as a set of elastic tensors, wherein respective elastic tensors of the set thereof have tilted orientations relative to the grid; and simulating wave propagation in the medium using a wave-equation operator, wherein the wave-equation operator is invariant to orientation changes of the respective elastic tensors of the set thereof.

A third aspect provides a computer, comprising a processor and a memory, configured to perform the method according to any of the first aspect and/or the second aspect;
a computer program comprising instructions which, when executed by a computer, comprising a processor and a memory, cause the computer to perform the method according to any of the first aspect and/or the second aspect; and/or
a tangible (optionally, a non-transitory) computer-readable recording medium storing instructions which, when executed by a computer, comprising a processor and a memory, cause the computer to perform the method according to any of the first aspect and/or the second aspect.

### BRIEF DESCRIPTION OF THE DRAWINGS

For a better understanding of the disclosure, and to show how implementations of the same may be brought into effect, reference will be made, by way of example only, to the accompanying diagrammatic Figures, in which:

FIG. 1 illustrates a cylinder and a Moebius strip.

FIG. 2 illustrates a frame bundle concept for TTI and TORT models.

FIG. 3 illustrates a method for simulating.

FIG. 4 illustrates an example computing system that may implement various aspects of the disclosure.

### DETAILED DESCRIPTION

### Simulating Seismic Wave Propagation

The first aspect provides a method of simulating seismic wave propagation in media, the method implemented by a computer comprising a processor and a memory, the method comprising: modelling, using an earth model having a grid, a medium as a set of elastic tensors, wherein respective elastic tensors of the set thereof have tilted orientations relative to the grid; and simulating seismic wave propagation in the medium using a wave-equation operator, wherein the wave-equation operator is invariant to orientation changes of the respective elastic tensors of the set thereof.

In this way, the simulation is improved compared with conventional simulations because the wave-equation operator is invariant to orientation changes of the respective elastic tensors of the set thereof, for example by accounting for and/or including respective orientations of the elastic tensors of the set thereof. In this way, the simulation is improved compared with conventional simulation, particularly where there are rapid and/or short-range spatial variations in tilt of the respective elastic tensors of the set thereof, for example in earth models having complex geological settings such as near reservoir bounding faults or salt bodies. In contrast, conventional simulations of such models typically suffer from numerical instabilities. In this way, imaging of earth models (e.g., Reverse Time Migration, RTM) and/or inference of earth model properties (e.g., Full Waveform Inversion, FWI, or in least-squares Reverse-time Migration, LSRTM) may be improved.

### Wave-Equation Operators

Conventional wave-equation operators designed for media having Tilted Transverse Isotropy (TTI) and Tilted Orthorhombic (TORT) symmetries have become standard in conventional seismic imaging for complex geological settings. These conventional wave-equation operators have been widely used in seismic exploration since the early 2000s, following the introduction of pseudo-acoustic approximations. Extensive research and development, particularly in the 2010s, have made these conventional wave-equation operators integral to Reverse Time Migration (RTM) and Full-Waveform Inversion (FWI) algorithms in both academic and industrial applications.

A common feature of these conventional wave-equation operators is the use of directional derivatives to account for the spatial variation of TTI and TORT symmetry axes. Despite their widespread application and success, directional derivatives have limitations because they are not truly covariant differential operators in general. Consequently, numerical instabilities arise, particularly when dealing with pronounced spatial variations in the tilt of symmetry axes. Various ad-hoc solutions, such as smoothing the tilt fields before simulations, have been proposed, but these approaches are not always satisfactory, especially in complex geological settings where rapid spatial variations in tilt are common and need to be considered (e.g., near reservoir bounding faults or salt bodies). These solutions often fail to address the root of the problem, leading to persistent challenges in finding stable adjoint operators for TTI and TORT media.

The method according to the first aspect addresses and/or overcomes the limitations of the conventional use of directional derivatives by providing a new mathematical framework that inherently accounts for the symmetries of the elastic tensor, for example by adding tensor orientation as another set of coordinates to the problem of seismic wave propagation.

Particularly, the method according to the first aspect may: transform velocity models into curved manifolds; provide adjoint differential operators for propagating waves in such curved manifolds; and/or recognize that the variable tilt of symmetry elements of the elastic tensor has physical meaning and is a direct manifestation of the curvature of the modelling space itself. This new framework leads to stable wave-equation operators for TTI and TORT symmetries, for example.

The disclosure provides a novel representation of heterogeneous and anisotropic earth models using mathematical structures called frame bundles, for example. In this representation, local frames align with the symmetry elements (axes or planes) of the elastic tensor at each point in the earth model.

This approach allows for the incorporation and leverage of the inherent symmetries of the elastic tensors characterizing an earth model. Consequently, wave-equation operators can be written that are invariant to spatial changes in the orientation of symmetry elements of the elastic tensor, which may have Tilted Transverse Isotropy (TTI), Tilted Orthorhombic (TORT), or Tilted Monoclinic symmetries, for example.

The disclosure provides simplified wave equations but endows their differential operators with a key attribute: it makes them compatible with the metric of the resulting frame-bundle manifold representing earth models. This compatibility ensures true adjoint operators even in the presence of rapid spatial variation of symmetry axes. This is a significant improvement over current state-of-the-art wave-equation operators, leading to more accurate and reliable seismic imaging and inversion results, as current operators for TTI and TORT media lack this property.

The method according to the first aspect offers a more intuitive and physically meaningful way to parameterize anisotropic earth models compared with conventional methods. The method according to the first aspect provides new physical insights into seismic wave phenomena in anisotropic and heterogeneous media because it connects topology to elastic tensor symmetry orientation. The earth models produced by the method according to the first aspect are mathematically coherent manifolds which are in general curved, with curvature (a topological property) proportional to the spatial variation of symmetry orientations. This topological information should be valuable for designing better inversion algorithms, because it provides unprecedented constraints on the estimations of symmetry orientations, which are typically assumed to be orthogonal to reflectors on depth-migrated seismic images, for example.

The method according to the first aspect is applicable to seismic imaging and inversion of seismic data in various settings, from exploration and production of hydrocarbons to monitoring of subsurface processes like CO₂ sequestration or hydraulic fracturing. The method according to the first aspect is general enough to be applied in other fields of science and engineering where wave phenomena in anisotropic elastic media are of interest.

The method according to the first aspect is also flexible to be used with various numerical methods, such as finite-difference, finite-element, and spectral-element methods, for solving wave-equation partial differential equations in pseudo-acoustic or elastic media. The method according to the first aspect may be employed for imaging methods (e.g., Reverse Time Migration, RTM) and/or inference of earth model properties (e.g., Full Waveform Inversion, FWI, or in least-squares Reverse-time Migration, LSRTM).

### Method

The method includes simulating seismic wave propagation in media. Generally, a solid body may be deformed by the application of an external force. If the solid body is perfectly elastic, the solid body will return to its original shape once that external force is removed. In the context of exploration seismology, the earth can generally be considered as perfectly elastic because the stresses generated by seismic exploration activities are too small to permanently deform subsurface rocks. When an impulsive or transitory stress is applied to a finite area on the surface of an elastic solid body, a strain is generated in the immediately adjacent sub-volume. The strained sub-volume then transfers stress in turn to mutually adjacent sub-volumes within the solid body, which generates strains in these mutually adjacent sub-volumes. In this way, an impulsive stress propagates through a solid body as an elastic wave. Elastic waves that propagate in the earth are known as seismic waves. Generally, a seismic wave is a mechanical wave of elastic energy that travels through the earth or another planetary body. The propagation velocity of a seismic wave depends on the density and the elasticity of the solid body as well as the type of wave. In one example, the media comprise and/or are solid bodies, for example planets, such as the earth, or parts, such as volumes, thereof.

In one example, the media comprise and/or are elastic media, for example perfectly elastic media and/or considered to be perfectly elastic media. In one example, the media comprise and/or are elastic solid bodies, for example perfectly elastic solid bodies and/or considered to be perfectly elastic solid bodies, for example planets, such as the earth, or parts, such as volumes, thereof. In one example, the media comprise and/or are heterogeneous and/or anisotropic media, for example as described with respect to the medium mutatis mutandis.

### Computer

The method is implemented by the computer comprising the processor and the memory. In other words, the method comprises and/or is a computer-implemented method.

### Modelling

The method comprises modelling, using the earth model having the grid, the medium as the set of elastic tensors (also known as elasticity tensors, elastic modulus tensors and stiffness tensors). Modelling, using an earth model having a grid, the medium as a set of elastic tensors is known, for example using a 2D or a 3D grid having points or nodes. Generally, an elasticity tensor is a fourth-rank tensor describing the stress-strain relation in a linear elastic material. A grid is also known as a computational grid or a coordinate system. The grid is used to represent, at least in part, the earth model and/or a part thereof.

The respective elastic tensors of the set thereof have tilted orientations relative to the grid. In this way, symmetry elements of different tensors at each point or node of the grid may be oriented differently, for example mutually differently. In one example, two or more mutually adjacent elastic tensors of the set thereof, for example at mutually adjacent points or nodes of the grid, have mutually different tilt orientations. In one example, for TTI symmetry, a symmetry element comprises an axis, for example a single axis, of rotation invariance by any angle (or equivalently, a plane of isotropy). In one example, for TORT media, symmetry elements comprise three mutually orthogonal axes of rotation invariance to angles equal to 180 degrees (or equivalently to three mutually perpendicular mirror symmetry planes).

In one implementation, the symmetry elements are spatially variable, for example varying from point to point or node to node on a grid such as a spatial coordinate grid, such as having different directions or orientations (i.e. tilts) and/or different magnitudes from point to point or node to node on a grid such as a spatial coordinate grid.

### Earth Model

Generally, an earth model is a representation of the Earth's internal structure, typically including parameters such as density, seismic P-waves velocity (α), and S-waves velocities (β).

In one implementation, the earth model comprises and/or is a heterogeneous earth model, for example comprising one or more heterogeneities having mutually different elasticities and/or densities, whereby respective propagation velocities of a seismic wave therein and/or therethrough are mutually different, such as one or more heterogeneous layers, one or more reservoirs such as one or more hydrocarbon reservoirs, one or more faults such as reservoir bounding faults and/or one or more included bodies such as salt bodies.

In one implementation, the earth model comprises and/or is an anisotropic earth model, for example comprising directionally dependent physical properties such as elasticity, whereby respective propagation velocities of a seismic wave are directionally dependent. Generally, anisotropy stems from the effects of inherent properties of rocks (e.g., like the alignment of phyllosilicate minerals) or from the combined effect of various thin layers of isotropic rocks in a sedimentary formation on the propagation of seismic wavefields. For example TTI symmetries are usually associated with thick sequences of shales in sedimentary basis, which show tilt in relation to the earth's surface because of various episodes of faulting or folding throughout the geologic time.

In one implementation, the earth model comprises and/or is a heterogeneous, anisotropic earth model.

### Medium

In one implementation, the medium comprises and/or is a solid body, for example a planet, such as the earth, or a part, such as a volume, thereof.

In one implementation, the medium comprises and/or is an elastic medium, for example a perfectly elastic medium and/or considered to be a perfectly elastic medium.

In one implementation, the medium comprises and/or is an elastic solid body, for example a perfectly elastic solid body and/or considered to be a perfectly elastic solid body, for example a planet, such as the earth, or a part, such as a volume, thereof.

In one implementation, the medium comprises and/or is a heterogeneous medium, for example comprising one or more heterogeneities having mutually different elasticities and/or densities, such as and/or due to mutually different textures, mineral composition, permeabilities and/or porosities, whereby respective propagation velocities of a seismic wave therein and/or therethrough are mutually different, such as one or more heterogeneous layers, one or more reservoirs such as one or more hydrocarbon reservoirs, one or more faults such as reservoir bounding faults and/or one or more included bodies such as salt bodies.

In one implementation, the medium comprises and/or is an anisotropic medium, for example comprising directionally dependent physical properties such as elasticity, such as whereby respective propagation velocities of a seismic wave are directionally dependent.

In one implementation, the medium comprises and/or is a heterogeneous, anisotropic medium.

In one implementation, the medium has Tilted Transverse Isotropy, TTI, symmetry, Tilted Orthorhombic, TORT, symmetry and/or Tilted Monoclinic symmetry, preferably TTI and/or TORT. Other symmetries are known.

### Simulating

In an implementation, the method comprises simulating seismic wave propagation in the medium using the wave-equation operator, wherein the wave-equation operator is invariant to orientation changes of the respective elastic tensors of the set thereof.

In this way, the simulation is improved compared with conventional simulations because the wave-equation operator is invariant to orientation changes of the respective elastic tensors of the set thereof, for example by accounting for and/or including respective orientations of the elastic tensors of the set thereof. In this way, the simulation is improved compared with conventional simulation, particularly where there are rapid and/or short-range spatial variations in tilt of the symmetry elements, for example in earth models having complex geological settings such as near reservoir bounding faults or salt bodies. In contrast, conventional simulations of such models typically suffer from numerical instabilities.

In one implementation, simulating seismic wave propagation in the medium using the wave-equation operator comprises aligning respective local frames of the wave-equation operator with the respective symmetry elements of the respective elastic tensors of the set thereof, for example at each point or node on a grid such as a spatial coordinate grid. In this way, the wave-equation operator is invariant to orientation changes of the respective elastic tensors of the set thereof.

### Fiber Bundles

In one implementation, aligning respective local frames of the wave-equation operator with the respective symmetry elements comprises providing the respective local frames by a fiber bundle. The fiber bundles provide a framework for anisotropic velocity models, for example, by generalizing Cartesian products, allowing the creation of complex manifolds, such as Riemannian manifolds describing elastic tensors by three spatial coordinates and three local orientation coordinates, by combining simpler ones, as described herein.

As detailed below, the fiber bundle approach splits the tangent space of the total space into two complementary pieces: one piece along the fibers and another piece perpendicular (more generally: complementary) to the fibers. Consequently, the connection operator (also known as the covariant derivative) acting on a vector or tensor field T defined over the total space manifold and taken along a vector X is given by the summation of two operators: D_{X}T=∇_{X}T+Σω(X) T, where ∇ represents the part of the connection accounting for changes in position in the base space, and ω for changes in the orientation of the elastic tensor (i.e., in the local frame orientations). The connection 1-form, ω, acts over each index of T, thus the summation symbol in the definition of D_{X}T. It should be understood that (differential) 1-forms are dual to vectors, i.e., on manifolds, 1-forms represent linear functions acting on vectors to produce scalars. For simplicity and to highlight the contribution of spatial variation of orientations of anisotropic axes into wave propagation, the base space is taken to represent a Euclidean space, such that ∇_{X}=∂_{X}, i.e., changes along base space directions are given by directional derivatives. Technical details aside, the operator w in the frame bundle has a very specific form: it is a skew-symmetric 3×3 matrix, whose elements are given by ω=h⁻¹dh, where h is the rotation/attitude matrix determining the orientation of the elastic tensors at each point in the anisotropic velocity model. Thus, ω is a model parameter, independent of propagation, which can be precomputed or obtained on the fly, once the attitude matrix is set, regardless of its parameterization using Euler angles or quaternions.

Given these preliminary theoretical considerations, any wave equation operator for media may be recast using the proposed frame-bundle approach. This may involve replacing any partial or directional derivatives with the bundle connection D and ensuring the resulting equation is frame independent. For example, starting from the wave equation (1):

$${\partial }_{t}^{2} {σ}_{ij} = {A}_{ij}^{kl} {\partial }_{l} {\partial }^{r} {σ}_{kr} \qquad ( 1 )$$

may be recast as equation (2):

$${\partial }_{t}^{2} {σ}_{ij} = {A}_{ij}^{kl} {D}_{l} {D}^{r} {σ}_{kr} = {A}_{ij}^{kl} {D ( tr ( D σ ) )}_{kl} = {{A}_{ij}^{kl} ( tr ( D ( D σ ) ) )}_{kl} \qquad ( 2 )$$

where A is the density-normalized elastic tensor and repetition of an index in one upstairs and one downstairs position indicates a summation over it (i.e., using Einstein's summation convention). After the second equality sign in equation 2, we switched to a more abstract notation to show that the action of the two connection operators D results in the gradient of the divergence of the stress tensor σ. Because D is compatible with the metric, it commutes with the trace operator and so one reaches the expression with the term D(Dσ). This is not a tensorial quantity, thus not frame independent. It is, nevertheless, part of the Hessian of the stress tensor,

$${D}_{X , Y}^{2} σ = {D}_{X} ( {D}_{Y} σ ) - {D}_{{D}_{X} Y} σ ,$$

winch is tensorial thanks to the extra term D_{D}_{_{X}}_{Y}σ (with X and Y being vectors in the manifold). Because equation (1), the starting point, is set up in a Euclidean manifold (where the second term of the Hessian is identically zero) the translation from directional derivatives to covariant ones requires that ∂^{l}∂ₛσ^{kr} be understood as the full Hessian. Thus, equation (2) may be written as equation (3):

$${\partial }_{t}^{2} {σ}_{i j} = {{A}_{i j}^{k l} [ t r ( {D}^{2} σ ) ]}_{k l} = - {A}_{i j}^{k l} Δ {σ}_{k l} \qquad ( 3 )$$

where Δσₖₗ represents the Laplacian of the stress tensor, which, however, is not simply the summation of second partial derivatives. In curved spaces, like the frame bundle, second covariant derivatives do not commute, but their difference defines a crucial quantity that measures the curvature of the total space itself, the curvature tensor R(X, Y), i.e. equation (4):

$${D}_{X , Y}^{2} σ - {D}_{Y , X}^{2} σ = {D}_{X} {D}_{Y} σ - {D}_{Y} {D}_{X} σ - {D}_{[ X , Y ]} σ = R ( X , Y ) σ \qquad ( 4 )$$

with [X, Y]=∂_{X}Y−∂_{Y}X also a vector. Equation (4) underscores that the Laplacian in equation (3) contains terms related to the curvature tensor, since explicitly from equation (5):

$$Δ σ = - t r [ {D}_{X , Y}^{2} σ ] = - t r [ {D}_{Y , X}^{2} σ + R ( X , Y ) σ ] \qquad ( 5 )$$

This is a physically insightful result: this equation shows that space curvature leads to extra accelerations in wave-equations because of elastic tensor misalignments. Here, curvature is created by misalignment of elastic tensors (in general relativity, by the presence of mass). Also, the wave equation describes how stress-waves propagate (the acceleration term) as a function of spatial changes in stress distribution (the Laplacian term). And the equation shows how the misalignment of elastic tensors creates extra terms in these spatial changes in stress, captured by the Laplacian. In more detail, firstly, it clarifies why the directional derivative approach runs into problems, because the resulting Laplacian operators would then not have terms with the connection 1-form ω (found in D) and the curvature R. Secondly, it links differences in orientation of symmetry axes in models, for example, to extra accelerations in the wave equation, coming from the action of the curvature (tensor) on the stress perturbations describing the waves. The following expression for the Laplacian of second-order tensors in Riemannian manifolds, is given by equation (6):

$${( Δ σ )}_{k l} = - {D}^{i} {D}_{i} {σ}_{k l} + R i {c}_{i k} {σ}_{l}^{i} + Ri {c}_{i l} {σ}_{k}^{i} - 2 {R}_{i j k l} {σ}^{ij} , \qquad ( 6 )$$

where Ric is the Ricci tensor, obtained from contraction of two indices of the curvature tensor R. The Lichnerowicz Laplacian in equation (6) is self-adjoint and it neatly separates the curvature effects when computing Laplacians. The term DⁱDᵢσₖₗ, the rough Laplacian, is what one would get if the manifold were flat. It comprises the familiar ∂ⁱ ∂ᵢσₖₗ terms plus terms with the connection 1-form ω. Note that the Laplacian returns a tensor of the same dimension and having the same symmetries of the input tensor. In the frame bundle, this means that Δσ can also be represented by a 3×3 symmetric matrix. Both the curvature and the Ricci tensors are evaluated to where the wavefield is, making finite-difference stencils redundant and thus having negligible impact on numerical computations during propagation. The curvature tensor R can be calculated from the metric tensor of the bundle but is more efficiently computed from the connection 1-form. Indeed, the covariant derivative of @ results in another skew-symmetric 3×3 matrix, given by equation (7):

$$Ω ( X , Y ) = ( D ω ) ( X , Y ) = {\partial }_{X} ω ( Y ) - {\partial }_{Y} ω ( X ) + ω ( X ) ∧ ω ( Y ) \qquad ( 7 )$$

A standard result of differential geometry then connects the matrix Ω to the curvature tensor R, because each element of this matrix Ω is a function of the components of the curvature tensor R in a local coordinate frame xⁱ, given by equation (8):

$${Ω}_{j}^{i} = \frac{1}{2} {R}_{jkl}^{i} d {x}^{k} ∧ d {x}^{l} \qquad ( 8 )$$

Both equations (7) and (8) include the wedge product Λ, the product operation for differential forms. The wedge product Λ is the tensor product followed by an antisymmetrization operation, which consists of summation over all components of the tensor product, but applying alternating signs based on the permutation of the indices in each term. The antisymmetrization ensures that the resulting differential k-forms are always alternating functions of k input vectors, thus encoding in them oriented lines, planes, volumes, and their higher-dimensional counterparts, enabling and streamlining calculus (and thereby wave propagation) in general manifolds. The wedge product Λ allows for the combination of lower-dimensional forms into higher-dimensional ones. For example, wedging two 1-forms produces a 2-form, an alternating bilinear function that takes two vectors and outputs the oriented area spanned by them in the plane of the 2-form, with the sign of the result changing whenever one swaps the order of the input vectors. Thus, in equation (8), the elements of the matrix Ω are summations of 2-forms whose coefficients are the components of the curvature tensor R and the unit areas dx^{k}Λdx^{l} are defined by wedging the 1-forms dx^{k} and dx^{l} related to a set of coordinates xⁱ (i=1, . . . , N) used to locally parametrize the frame bundle.

With all the elements above, one is now able to write covariant wave equations for media, as above, going from equation (1) to equation (3), for example. The key point is that defining a frame bundle parameterized by the local orientation of elastic stiffness tensors provides wave equations that are invariant to changes in the orientation of the symmetry axes of these same elastic tensors.

In one implementation, providing the respective local frames by the fiber bundle comprises attaching a copy of an orientation grid (for example, of the respective symmetry elements) to respective points (or nodes) in a spatial coordinate grid of the earth model. In this way, elastic tensor orientation may be decoupled from the spatial geometry.

In one implementation, providing the respective local frames by the fiber bundle comprises representing space of all orientations of respective local frames (for example, describing the local coordinate axes) using the respective fibers. In this way, an abstraction is provided to enable deployment of the fiber bundles to understand elastic wave propagation in the model. In this way, a connection operator may be defined, as described herein, that is compatible with a metric of a 6D manifold, for example. This has two significant consequences: firstly, it ensures that one can obtain true adjoint operators for wave propagation in the frame bundle manifold; and secondly, it provides differential operators that automatically account for spatial changes in orientation of symmetry axes, for example TTI or TORT symmetry axes, when taking (covariant) derivatives, thereby simplifying equations and numerical implementations, as there is no longer need to do and track rotations of elastic tensors or of directional derivatives, for example.

In one implementation, providing the respective local frames by the fiber bundle comprises representing the respective local frames axially and complementary to the respective fibers. In this way, the fiber bundle splits the tangent space of the total space into two complementary pieces: one piece along the fibers and another piece perpendicular (more generally: complementary) to the fibers. Consequently, the connection operator (also known as the covariant derivative) acting on a vector or tensor field defined over the total space manifold and taken along a vector is given by the summation of two operators, as described herein.

In one implementation, providing the respective local frames by the fiber bundle comprises providing the respective local frames by the fiber bundle having six dimensions, for example generally curved manifolds; wherein a base space provides coordinates for location in 3D space; and wherein respective fibers represent orientation manifolds, for example parameterized by coordinates and describing respective local orientations of the respective symmetry elements. In this way, by defining a frame bundle parameterized by the local orientation of elastic stiffness tensors, wave equations are provided that are invariant to changes in the orientation of the symmetry axes of these same elastic tensors.

### Outputting, Imaging, Inference & Adjusting

In one implementation, the method comprises outputting a result of simulating seismic wave propagation in the medium. In this way, the result of the simulating seismic wave propagation in the medium may be compared, for example, with a result of measuring seismic wave propagation in a physical medium (i.e. the medium that has been modelled, for example represented with a subsurface model).

In one implementation, the method comprises comparing the result of simulating seismic wave propagation in the medium with a result of measuring seismic wave propagation in a physical medium. In one implementation, the method comprises determining one or more differences based on a result of the comparing. In one implementation, the method comprises updating the model based on the one or more differences. In one implementation, the method comprises iteratively updating the model, for example by repeating the outputting, the comparing, the determining and/or the updating. In this way, the model may be adjusted.

Provided is a method of seismic imaging of an earth model, comprising the method according to the first aspect. In this way, the seismic imaging may be compared, for example, with seismic imaging of a physical medium (i.e. the medium that has been modelled, for example represented with a subsurface model).

Provided is a method of seismic inference of an earth model, comprising the method according to the first aspect. In this way, properties of a physical medium (i.e. the medium that has been modelled, for example represented with a subsurface model) may be inferred from the seismic inference.

Provided is a method of adjusting an earth model, comprising the method according to the first aspect.

Provided is a method of inversion of seismic data, comprising the method according to the first aspect.

Provided is a method of, in one implementation, the method provides a method of and/or in one example the method comprises seismic wave propagation modelling in heterogeneous and anisotropic elastic media with TTI or TORT symmetry, using fiber bundle theory to derive wave-equations that are invariant to orientation changes of symmetry elements (axes or planes) throughout an earth model.

Provided is a method of, in one implementation, the method provides a method of and/or in one example the method comprises defining heterogeneous anisotropic velocity models as frame bundles of six dimensions that are generally curved manifolds, in which the base space provides the coordinates for location in 3D space, while the fibers represent orientation manifolds (e.g., the group of rotations in 3D), parameterized by another three coordinates and describing the local orientation of symmetry elements of the elastic stiffness tensor.

Provided is a method of, in one implementation, the method provides a method of and/or in one implementation the method comprises defining a connection operator that is compatible with the metric of the resulting frame bundle manifold, ensuring by design true adjoint differential operators in wave propagation and accounting for spatial changes in the orientation of TTI or TORT symmetry axes.

Provided is a method of, in one implementation, the method provides a method of and/or in one implementation the method comprises simplifying wave equations and their numerical implementations by using connection operators that automatically account for spatial changes in elastic tensor orientations, eliminating the need to track relative rotations/orientations of these tensors or of differential operators.

Provided is a method of, in one implementation, the method provides a method of and/or in one implementation the method comprises improving stability and reducing numerical artifacts in wavefield simulations (in comparison to state-of-the art methods using directional derivatives) by using the afore-mentioned connection operators and corresponding 2-form connection curvature to accurately account for spatial variation of orientation of elastic tensors in a velocity model.

Provided is a method of, in one implementation, the method provides a method of and/or in one implementation the method comprises lending physical meaning to orientation changes of symmetry elements as manifold curvature that creates new tidal forces in wave equations, providing new insights into the behavior of wavefields propagating in heterogeneous and anisotropic elastic media.

Provided is a method of, in one implementation the method provides a method of and/or in one implementation the method comprises introducing new model parameters constraints in the forms of a curvature tensor (or equivalently the 2-form connection curvature) and its various contractions (Ricci tensor and scalar curvature) for inversion problems, providing new ways to estimate symmetry orientations from seismic data.

Provided is a method of, in one implementation the method provides a method of and/or in one implementation the method comprises enhancing reflectivity and velocity model estimation in inverse problems such as LSRTM or FWI by using the frame bundle approach to obtain superior fit between observed and modelled data and to separate the effects of curvature stemming from underlying space geometry from those caused by misalignments of elastic tensor orientations.

Provided is a method of, in one implementation, the method provides a method of and/or in one implementation the method comprises developing more accurate and efficient solvers that can adaptively account for frame rotations, leveraging the frame bundle approach to improve wave propagation modelling in anisotropic media.

Provided is a method of, in one implementation, the method provides a method of and/or in one implementation the method comprises extending wave propagation modelling to tilted Monoclinic symmetry cases by using elastic tensors with monoclinic symmetry.

Provided is a method of, in one implementation, the method provides a method of and/or in one implementation the method comprises encouraging further investigation into orientation parameterization, such as using Euler angles or quaternions, to improve the accuracy and efficiency of wave propagation modelling in anisotropic media.

### Simulating Wave Propagation

The second aspect provides a method of simulating wave propagation in media, the method implemented by a computer comprising a processor and a memory, the method comprising: modelling, using a model having a grid, a medium as a set of elastic tensors, wherein respective elastic tensors of the set thereof have tilted orientations relative to the grid; and simulating wave propagation in the medium using a wave-equation operator, wherein the wave-equation operator is invariant to orientation changes of the respective elastic tensors of the set thereof.

The method according to the second aspect may be as described and/or include any step as described with respect to the first aspect, mutatis mutandis.

In one implementation, the media comprise and/or are solid bodies, for example biological bodies such as anatomical bodies or structural bodies such as manufactured components or assemblies, or parts, such as volumes, thereof. In one implementation, the media comprise and/or are elastic media, for example perfectly elastic media and/or considered to be perfectly elastic media. In one implementation, the media comprise and/or are elastic solid bodies, for example perfectly elastic solid bodies and/or considered to be perfectly elastic solid bodies, for example biological bodies such as anatomical bodies or structural bodies such as manufactured components or assemblies, or parts, such as volumes, thereof. In one example, the media comprise and/or are heterogeneous and/or anisotropic media, for example as described with respect to the medium mutatis mutandis.

Provided is a method of imaging of a model, comprising the method according to the second aspect.

Provided is a method of inference of a model, comprising the method according to the second aspect.

Provided is a method of adjusting a model, comprising the method according to the second aspect.

Provided is a method of inversion of data, comprising the method according to the second aspect.

Computer, Computer Program and/or CRM

The third aspect provides a computer, comprising a processor and a memory, configured to perform the method according to any of the first aspect and/or the second aspect;
a computer program comprising instructions which, when executed by a computer, comprising a processor and a memory, cause the computer to perform the method according to any of the first aspect and/or the second aspect; and/or
a tangible (optionally, a non-transitory) computer-readable recording medium storing instructions which, when executed by a computer, comprising a processor and a memory, cause the computer to perform the method according to any of the first aspect and/or the second aspect.

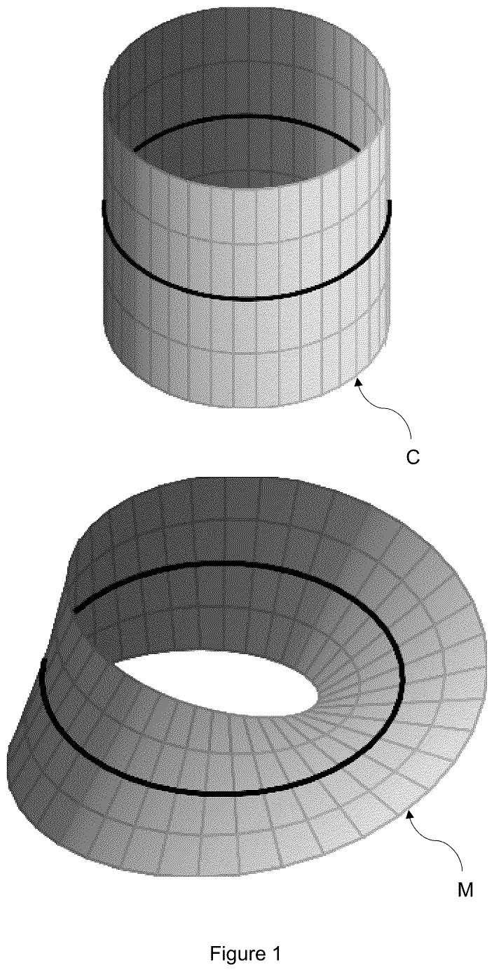

The disclosure applies concepts of differential geometry to the problem of seismic wave propagation in heterogeneous anisotropic elastic media. The anisotropic velocity models are conceptualized as Riemannian manifolds described by six coordinates: three spatial coordinates and another three for the local orientation of the elastic tensor. This parameterization is locally trivial but globally complex, akin to how the Earth's surface appears locally flat (i.e., Euclidean) but is globally curved. Thus, anisotropic velocity models are not six-dimensional Euclidean spaces and instead require a more sophisticated framework. Fiber bundles provide this framework by generalizing Cartesian products, allowing the creation of complex manifolds by combining simpler ones. In this case, this combination (known as a fiber bundle) results from attaching a copy of the orientation grid (a manifold on its own) to every point in the spatial coordinate grid (the base space, also known as the base manifold). These fibers can “twist” as they attach to the base space, creating intricate global structures, which are stitched together smoothly by transition functions. The fiber bundle is characterized by the combined total space, the base space, and a projection map that matches points from the total space to the base space. Classic illustrations of fiber bundles are a cylinder and a Moebius strip. Both the cylinder and the Moebius strip may be represented by the combination of a circle as a base space with a real line representing the fibers attached to each point of that circle. Locally, both the cylinder C and the Moebius strip M look like Euclidean spaces, but in the Moebius strip, the orientation of the fibers changes along or around the circle, resulting in a total space that is not a cylinder (see FIG. 1). Referring to FIG. 1, the cylinder and the Moebius strip are two fiber bundles created by attaching copies of the real line (the fibers) to a circle (the base space). Locally they can be represented by the same flat space, but their global topologies are widely different because how the fibers twist in the Moebius strip. Finally, connections extend the notion of directional derivatives to fiber bundles. In curved spaces, connections allow the parallel transport of vectors and tensors along curves in the base space, enabling their comparison and differentiation across different fibers.

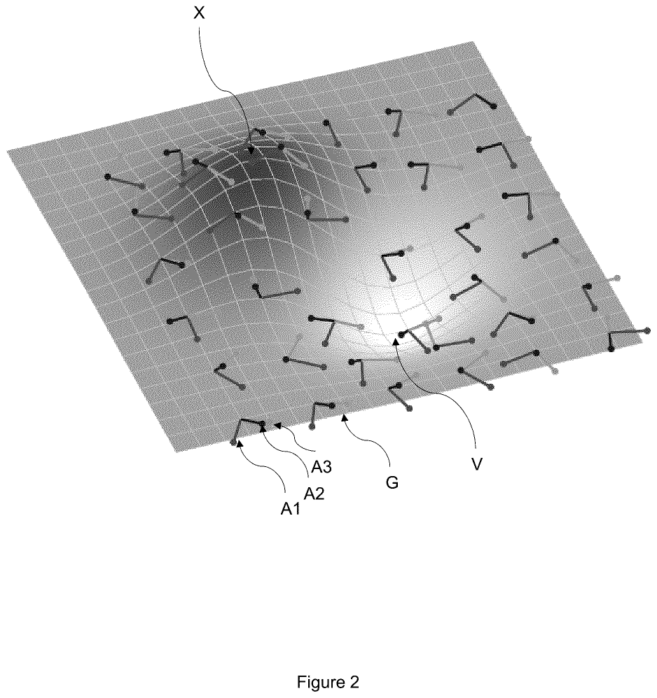

In the description of TTI or TORT velocity models (more generally: velocity models) herein, the so-called frame bundle is used, where the fiber represents the space of all orientations of the frame describing the local coordinate axes. The total space model is characterized by a local frame at each point in the base space, taken to be the same frame in which elastic tensors are given by their smallest number of parameters (for example, five in the case of TTI and nine for TORT; see FIG. 2). Referring to FIG. 2, the 2-D surface, including a concavity V and a convexity X, represents the computational grid G, which determines the spatial discretization of the model using general curvilinear grids. The mutually perpendicular axes A1, A2, A3 show local frame orientations that are attached to the base space but align with the elastic tensor symmetry elements at each grid position, not to the geometry of the underlying base space. This way, elastic tensor orientation is decoupled from the underlying spatial geometry. This abstraction enables deployment of the powerful tools of fiber bundles to understand elastic wave propagation in anisotropic models in a novel way. At once, it allows for a connection operator to be defined that is compatible with the metric of the 6D manifold. This has two significant consequences: firstly, it ensures that one can obtain true adjoint operators for wave propagation in the frame bundle manifold; and secondly, it provides differential operators that automatically account for spatial changes in orientation of symmetry axes, for example TTI or TORT symmetry axes, when taking (covariant) derivatives, thereby simplifying equations and numerical implementations, as there is no longer need to do and track rotations of elastic tensors or of directional derivatives, for example.

The fiber bundle approach splits the tangent space of the total space into two complementary pieces: one piece along the fibers and another piece perpendicular (more generally: complementary) to the fibers. Consequently, the connection operator (also known as the covariant derivative) acting on a vector or tensor field T defined over the total space manifold and taken along a vector X is given by the summation of two operators: D_{X}T=∇_{X}T+Σω(X)T, where ∇ represents the part of the connection accounting for changes in position in the base space, and ω for changes in the orientation of the elastic tensor (i.e., in the local frame orientations). The connection 1-form, ω, acts over each index of T, thus the summation symbol in the definition of D_{X}T. It should be understood that (differential) 1-forms are dual to vectors, i.e., on manifolds, 1-forms represent linear functions acting on vectors to produce scalars. For simplicity and to highlight the contribution of spatial variation of orientations of anisotropic axes into wave propagation, the base space is taken to represent a Euclidean space, such that ∇_{X}=∂_{X}, i.e., changes along base space directions are given by directional derivatives. Technical details aside, the operator ω in the frame bundle has a very specific form: it is a skew-symmetric 3×3 matrix, whose elements are given by w=h⁻¹dh, where h is the rotation/attitude matrix determining the orientation of the elastic tensors at each point in the anisotropic velocity model. Thus, w is a model parameter, independent of propagation, which can be precomputed or obtained on the fly, once the attitude matrix is set, regardless of its parameterization using Euler angles or quaternions.

Given these preliminary theoretical considerations, any wave equation operator for media with TTI or TORT symmetries, for example, may be recast using the proposed frame-bundle approach. This may involve replacing any partial or directional derivatives with the bundle connection D and ensuring the resulting equation is frame independent. For example, starting from the wave equation written in terms of stress tensor σ components and considering constant density, equation (1):

$${\partial }_{t}^{2} {σ}_{i j} = {A}_{i j}^{k l} {\partial }_{l} {\partial }^{r} {σ}_{k r} \qquad ( 1 )$$

may be recast as equation (2):

$${\partial }_{t}^{2} {σ}_{i j} = {A}_{i j}^{k l} {D}_{l} {D}^{r} {σ}_{k r} = {A}_{i j}^{k l} {D ( t r ( D σ ) )}_{k l} = {{A}_{i j}^{k l} ( t r ( D ( D σ ) ) )}_{k l} \qquad ( 2 )$$

where A is the density-normalized elastic tensor and repetition of an index in one upstairs and one downstairs position indicates a summation over it (i.e., using Einstein's summation convention). After the second equality sign in equation 2, we switched to a more abstract notation to show that the action of the two connection operators D results in the gradient of the divergence of the stress tensor σ. Because D is compatible with the metric, it commutes with the trace operator and so one reaches the expression with the term D(Dσ). This is not a tensorial quantity, thus not frame independent. It is, nevertheless, part of the Hessian of the stress tensor,

$${D}_{X , Y}^{2} σ = {D}_{X} ( {D}_{Y} σ ) - {D}_{{D}_{X} Y} σ ,$$

which is tensorial thanks to the extra term D_{D}_{_{X}}_{Y}σ (with X and Y being vectors in the manifold). Because equation (1), the starting point, is set up in a Euclidean manifold (where the second term of the Hessian is identically zero) the translation from directional derivatives to covariant ones requires that ∂^{l}∂ₛσ^{kr} be understood as the full Hessian. Thus, equation (2) may be written as equation (3):

$${\partial }_{t}^{2} {σ}_{i j} = {{A}_{i j}^{k l} [ t r ( {D}^{2} σ ) ]}_{k l} = - {A}_{i j}^{k l} Δ {σ}_{k l} \qquad ( 3 )$$

where Δσₖₗ represents the Laplacian of the stress tensor, which, however, is not simply the summation of second partial derivatives. In curved spaces, like the frame bundle, second covariant derivatives do not commute, but their difference defines a crucial quantity that measures the curvature of the total space itself, the curvature tensor R(X, Y), i.e. equation (4):

$${D}_{X , Y}^{2} σ - {D}_{Y , X}^{2} σ = {D}_{X} {D}_{Y} σ - {D}_{Y} {D}_{X} σ - {D}_{[ X , Y ]} σ = R ( X , Y ) σ \qquad ( 4 )$$

with [X, Y]=∂_{X}Y−∂_{Y}X also a vector. Equation (4) underscores that the Laplacian in equation (3) contains terms related to the curvature tensor, since explicitly from equation (5):

$$Δ σ = - t r [ {D}_{X , Y}^{2} σ ] = - t r [ {D}_{Y , X}^{2} σ + R ( X , Y ) σ ] \qquad ( 5 )$$

This is a physically insightful result: this equation shows that space curvature leads to extra accelerations in wave-equations because of elastic tensor misalignments. Like in General relativity, where Gravity is a force stemming from the curvature of space-time. Here, curvature is created by misalignment of elastic tensors (in general relativity, by the presence of mass). Also, the wave equation describes how stress-waves propagate (the acceleration term) as a function of spatial changes in stress distribution (the Laplacian term). And the equation shows how the misalignment of elastic tensors creates extra terms in these spatial changes in stress, captured by the Laplacian. In more detail, firstly, it clarifies why the directional derivative approach runs into problems, because the resulting Laplacian operators would then not have terms with the connection 1-form ω (found in D) and the curvature R. Secondly, it links differences in orientation of symmetry axes in TTI and TORT models, for example, to extra accelerations (akin to tidal forces) in the wave equation, coming from the action of the curvature (tensor) on the stress perturbations describing the waves. The following expression for the Laplacian of second-order tensors in Riemannian manifolds, as given by equation (6):

$${( Δ σ )}_{k l} = - {D}^{i} {D}_{i} {σ}_{k l} + R i {c}_{i k} {σ}_{l}^{i} + Ri {c}_{i l} {σ}_{k}^{i} - 2 {R}_{i j k l} {σ}^{ij} , \qquad ( 6 )$$

where Ric is the Ricci tensor, obtained from contraction of two indices of the curvature tensor R. The Lichnerowicz Laplacian in equation (6) is self-adjoint and it neatly separates the curvature effects when computing Laplacians. The term DⁱDᵢσₖₗ, the rough Laplacian, is what one would get if the manifold were flat. It comprises the familiar ∂ⁱ ∂ᵢσₖₗ terms plus terms with the connection 1-form ω. Note that the Laplacian returns a tensor of the same dimension and having the same symmetries of the input tensor. In the frame bundle, this means that Δσ can also be represented by a 3×3 symmetric matrix. Both the curvature and the Ricci tensors are evaluated to where the wavefield is, making finite-difference stencils redundant and thus having negligible impact on numerical computations during propagation. The curvature tensor R can be calculated from the metric tensor of the bundle but is more efficiently computed from the connection 1-form. Indeed, the covariant derivative of ω results in another skew-symmetric 3×3 matrix, given by equation (7):

$$Ω ( X , Y ) = ( D ω ) ( X , Y ) = {\partial }_{X} ω ( Y ) - {\partial }_{Y} ω ( X ) + ω ( X ) ∧ ω ( Y ) \qquad ( 7 )$$

A standard result of differential geometry then connects the matrix Ω to the curvature tensor R, because each element of this matrix Ω is a function of the components of the curvature tensor R in a local coordinate frame xⁱ, given by equation (8):

$${Ω}_{j}^{i} = \frac{1}{2} {R}_{jkl}^{i} d {x}^{k} ∧ d {x}^{l} \qquad ( 8 )$$

Both equations (7) and (8) include the wedge product Λ, the product operation for differential forms. The wedge product A is the tensor product followed by an antisymmetrization operation, which consists of summation over all components of the tensor product, but applying alternating signs based on the permutation of the indices in each term. The antisymmetrization ensures that the resulting differential k-forms are always alternating functions of k input vectors, thus encoding in them oriented lines, planes, volumes, and their higher-dimensional counterparts, enabling and streamlining calculus (and thereby wave propagation) in general manifolds. The wedge product A allows for the combination of lower-dimensional forms into higher-dimensional ones. For example, wedging two 1-forms produces a 2-form, an alternating bilinear function that takes two vectors and outputs the oriented area spanned by them in the plane of the 2-form, with the sign of the result changing whenever one swaps the order of the input vectors. Thus, in equation (8), the elements of the matrix Ω are summations of 2-forms whose coefficients are the components of the curvature tensor R and the unit areas dx^{k}Λdx^{l} are defined by wedging the 1-forms dx^{k} and dx^{l} related to a set of coordinates xⁱ (i=1, . . . , N) used to locally parametrize the frame bundle.

With all the elements above, one is now able to write covariant wave equations for TTI and TORT media, for example, as above, going from equation (1) to equation (3), for example. The key point is that defining a frame bundle parameterized by the local orientation of elastic stiffness tensors provides wave equations that are invariant to changes in the orientation of the symmetry axes of these same elastic tensors.

The disclosure herein provides a new, mathematically rigorous method to wave propagation in heterogeneous elastic and anisotropic models with TTI or TORT symmetry, for example. This new method can be naturally extended to deal, for example, with tilted Monoclinic symmetry cases as well, by simply using elastic tensors with monoclinic symmetry, which are characterized by 13 independent non-zero elements, while these are five for TTI and nine for TORT. By conceptualizing velocity models as frame bundles, where local coordinate frames align with the natural frame of elastic tensors, this new method generalizes and improves upon current practice of using directional derivatives. This new method encodes frame rotations directly into covariant wave equations, ensuring differential operators are compatible with the metric of the new manifold formed by combining spatial dimensions with the orientation manifold. This new method may enhance stability and/or reduce numerical artifacts in wavefield simulations, potentially improving reflectivity and velocity model estimation in inverse problems like LSRTM or FWI. This new method also provides several insights and benefits for wave propagation in anisotropic media, for example: it separates the effects of the underlying space geometry from those of elastic tensor orientation, lends physical meaning to orientation changes of symmetry elements as new tidal forces, introduces a new model parameter constraint in the form of a curvature tensor for inversion problems, and opens avenues for developing more accurate and efficient solvers that can adaptively account for frame rotations. Additionally, this new method encourages further investigation into orientation parameterization, such as using Euler angles or quaternions.

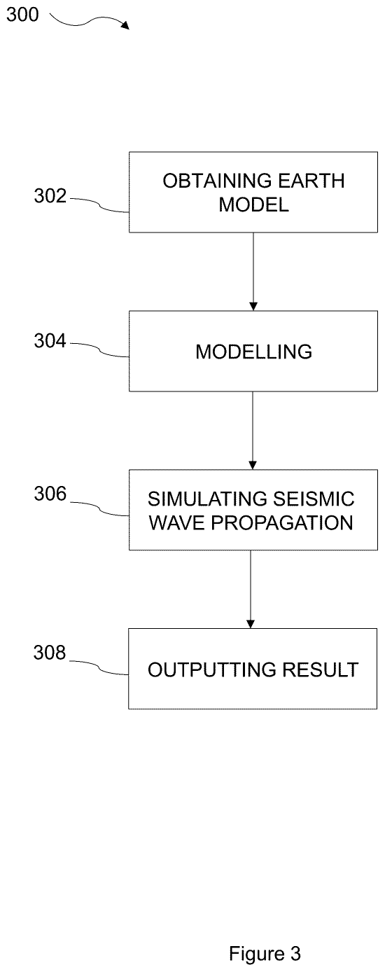

FIG. 3 schematically depicts a method 300 according to an implementation for simulating seismic wave propagation in media. The method is implemented by a computer comprising a processor and a memory. At step 302, the method comprises obtaining an earth model having a grid. At step 304, the method 300 includes modelling, using the earth model, a medium as a set of elastic tensors, wherein respective elastic tensors of the set thereof have tilted orientations relative to the grid. At step 306, the method 300 simulating seismic wave propagation in the medium using a wave-equation operator, wherein the wave-equation operator is invariant to orientation changes of the respective elastic tensors of the set thereof. At step 308, the method 300 includes outputting a result of simulating seismic wave propagation, such as for example using a display.

It is to be understood that the specific order or hierarchy of operations in the method depicted in FIG. 3 and throughout this disclosure are instances of example approaches and can be rearranged while remaining within the disclosed subject matter. For instance, any of the operations depicted in FIG. 3 may be omitted, repeated, performed in parallel, performed in a different order, and/or combined with any other of the operations depicted in FIG. 3 or discussed herein.

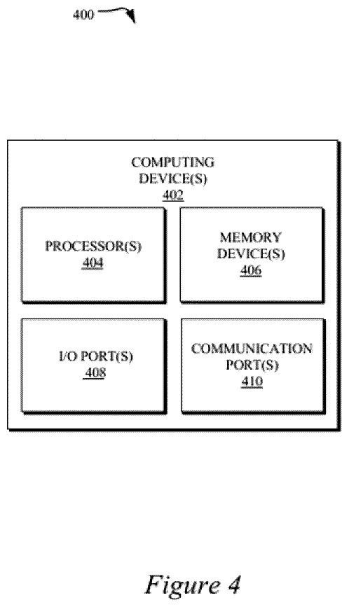

Turning to FIG. 4, a system 400 to process communication data can include one or more computing devices 402 for performing the techniques discussed herein. In one implementation, the one or more computing devices 402 include a computing device and/or one or more servers of a processing system to generate and execute the techniques discussed herein as a software application and/or a module or algorithmic component of software.

In some instances, the computing device 402 can include a computer, a personal computer, a desktop computer, a laptop computer, a terminal, a workstation, a server device, a cellular or mobile phone, a mobile device, a smart mobile device a tablet, a wearable device (e.g., a smart watch, smart glasses, a smart epidermal device, etc.) a multimedia console, a television, an Internet-of-Things (IoT) device, a smart home device, a medical device, a virtual reality (VR) or augmented reality (AR) device, a vehicle (e.g., a smart bicycle, an automobile computer, etc.), and/or the like. The computing device 402 may be integrated with, form a part of, or otherwise be associated with the system 400. It will be appreciated that specific implementations of these devices may be of differing possible specific computing architectures not all of which are specifically discussed herein but will be understood by those of ordinary skill in the art.

The computing device 402 may be a computing system capable of executing a computer program product to execute a computer process. Data and program files may be input to the computing device 402, which reads the files and executes the programs therein. Some of the elements of the computing device 402 include one or more processors 404, one or more memory devices 406, and/or one or more ports, such as input/output (IO) port(s) 408 and communication port(s) 410. Additionally, other elements that will be recognized by those skilled in the art may be included in the computing device 402 but are not explicitly depicted in FIG. 4 or discussed further herein. Various elements of the computing device 402 may communicate with one another by way of the communication port(s) 410 and/or one or more communication buses, point-to-point communication paths, or other communication means.

The processor 404 may include, for example, a central processing unit (CPU), a microprocessor, a microcontroller, a digital signal processor (DSP), and/or one or more internal levels of cache. There may be one or more processors 404, such that the processor 404 comprises a single central-processing unit, or a plurality of processing units capable of executing instructions and performing operations in parallel with each other, commonly referred to as a parallel processing environment.

The computing device 402 may be a conventional computer, a distributed computer, or any other type of computer, such as one or more external computers made available via a cloud computing architecture. The presently described technology is optionally implemented in software stored on the data storage device(s) such as the memory device(s) 406, and/or communicated via one or more of the I/O port(s) 408 and the communication port(s) 410, thereby transforming the computing device 402 in FIG. 4 to a special purpose machine for implementing the operations described herein. Moreover, the computing device 402, as implemented in the system 400, receives various types of input data (e.g., the input data, well data, etc.) and transforms the input data through various stages of the data flow into new types of data files (e.g., the simulation). Moreover, these new data files are transformed further into the prediction data and sent to the computing device 104 to provide information regarding the simulation, which enables the computing device 402 to do something it could not do before—simulating seismic wave propagation in media.

Additionally, the systems and operations disclosed herein represent an improvement to the technical field of machine modeling. For instance, the system 400 can generate estimate data with less data and fewer computing resources without human intervention. Moreover, data can be leveraged to provide a highly efficient and effective estimation of data. These techniques are rooted in technology and could not have existed prior to the advent of simulation software.

The one or more memory device(s) 406 may include any non-volatile data storage device capable of storing data generated or employed within the computing device 402, such as computer executable instructions for performing a computer process, which may include instructions of both application programs and an operating system (OS) that manages the various components of the computing device 402. The memory device(s) 406 may include, without limitation, magnetic disk drives, optical disk drives, solid state drives (SSDs), flash drives, and the like. The memory device(s) 406 may include removable data storage media, non-removable data storage media, and/or external storage devices made available via a wired or wireless network architecture with such computer program products, including one or more database management products, web server products, application server products, and/or other additional software components. Examples of removable data storage media include Compact Disc Read-Only Memory (CD-ROM), Digital Versatile Disc Read-Only Memory (DVD-ROM), magneto-optical disks, flash drives, and the like. Examples of non-removable data storage media include internal magnetic hard disks, SSDs, and the like. The one or more memory device(s) 406 may include volatile memory (e.g., dynamic random access memory (DRAM), static random access memory (SRAM), etc.) and/or non-volatile memory (e.g., read-only memory (ROM), flash memory, etc.).

Computer program products containing mechanisms to effectuate the systems and methods in accordance with the presently described technology may reside in the memory device(s) 406 which may be referred to as machine-readable media. It will be appreciated that machine-readable media may include any tangible non-transitory medium that is capable of storing or encoding instructions to perform any one or more of the operations of the present disclosure for execution by a machine or that is capable of storing or encoding data structures and/or modules utilized by or associated with such instructions. Machine-readable media may include a single medium or multiple media (e.g., a centralized or distributed database, and/or associated caches and servers) that store the one or more executable instructions or data structures.

In some implementations, the computing device 402 includes one or more ports, such as the I/O port(s) 408 and the communication port(s) 410, for communicating with other computing, network, or vehicle computing devices. It will be appreciated that the I/O port 408 and the communication port 410 may be combined or separate and that more or fewer ports may be included in the computing device 402.

The I/O port 408 may be connected to an I/O device, or other device, by which information is input to or output from the computing device 402. Such I/O devices may include, without limitation, one or more input devices, output devices, and/or environment transducer devices.

In one implementation, the input devices convert a human-generated signal, such as, human voice, physical movement, physical touch or pressure, and/or the like, into electrical signals as input data into the computing device 402 via the I/O port 408. Similarly, the output devices may convert electrical signals received from the computing device 402 via the I/O port 408 into signals that may be sensed as output by a human, such as sound, light, and/or touch. The input device may be an alphanumeric input device, including alphanumeric and other keys for communicating information and/or command selections to the processor 404 via the I/O port 408. The input device may be another type of user input device including, but not limited to direction and selection control devices, such as a mouse, a trackball, cursor direction keys, a joystick, and/or a wheel; one or more sensors, such as a camera, a microphone, a positional sensor, an orientation sensor, an inertial sensor, and/or an accelerometer; and/or a touch-sensitive display screen (“touchscreen”). The output devices may include, without limitation, a display, a touchscreen, a speaker, a tactile and/or haptic output device, and/or the like. In some implementations, the input device and the output device may be the same device, for example, in the case of a touchscreen.

The environment transducer devices convert one form of energy or signal into another for input into or output from the computing device 402 via the I/O port 408. For example, an electrical signal generated within the computing device 402 may be converted to another type of signal, and/or vice-versa. In one implementation, the environment transducer devices sense characteristics or aspects of an environment local to or remote from the computing device 402, such as, light, sound, temperature, pressure, magnetic field, electric field, chemical properties, physical movement, orientation, acceleration, gravity, and/or the like.

In one implementation, the communication port 410 is connected to the network(s) 112 so the computing device 402 can receive network data useful in executing the methods and systems set out herein as well as transmitting information and network configuration changes determined thereby. Stated differently, the communication port 410 connects the computing device 402 to one or more communication interface devices configured to transmit and/or receive information between the computing device 402 and other devices by way of one or more wired or wireless communication networks or connections. Examples of such networks or connections include, without limitation, Universal Serial Bus (USB), Ethernet, Wi-Fi, Bluetooth®, Near Field Communication (NFC), and so on. One or more such communication interface devices may be utilized via the communication port 410 to communicate with one or more other machines, either directly over a point-to-point communication path, over a wide area network (WAN) (e.g., the Internet), over a local area network (LAN), over a cellular network (e.g., third generation (3G), fourth generation (4G), Long-Term Evolution (LTE), fifth generation (5G), etc.) or over another communication means. Further, the communication port 410 may communicate with an antenna or other link for electromagnetic signal transmission and/or reception.

In an example, software, modules, services, and operations discussed herein may be embodied by instructions stored on the memory device(s) 406 and executed by the processor 404.

The system set forth in FIG. 4 is but one possible example of a computing device 402 or computer system that may be configured in accordance with aspects of the present disclosure. It will be appreciated that other non-transitory tangible computer-readable storage media storing computer-executable instructions for implementing the presently disclosed technology on a computing system may be utilized. In the present disclosure, the methods disclosed may be implemented as sets of instructions or software readable by the computing device 402.

Although exemplary implementations have been shown and described, it will be appreciated by those skilled in the art that various changes and modifications might be made without departing from the scope of the disclosure, as defined in the appended claims and as described above.

At least some of the implementations described herein may be constructed, partially or wholly, using dedicated special-purpose hardware. Terms such as ‘component’, ‘module’ or ‘unit’ used herein may include, but are not limited to, a hardware device, such as circuitry in the form of discrete or integrated components, a Field Programmable Gate Array (FPGA) or Application Specific Integrated Circuit (ASIC), which performs certain tasks or provides the associated functionality. In some embodiments, the described elements may be configured to reside on a tangible, persistent, addressable storage medium and may be configured to execute on one or more processors. These functional elements may in some embodiments include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. Although the example embodiments have been described with reference to the components, modules and units discussed herein, such functional elements may be combined into fewer elements or separated into additional elements. Various combinations of optional features have been described herein, and it will be appreciated that described features may be combined in any suitable combination. In particular, the features of any one example embodiment may be combined with features of any other embodiment, as appropriate, except where such combinations are mutually exclusive. Throughout this specification, the term “comprising” or “comprises” means including the component(s) specified but not to the exclusion of the presence of others.

Furthermore, any term of degree such as, but not limited to, “substantially,” as used in the description and the appended claims, should be understood to include an exact, or a similar, but not exact configuration. Similarly, the terms “about” or “approximately,” as used in the description and the appended claims, should be understood to include the recited values or a value that is three times greater or one third of the recited values. For example, about 3 mm includes all values from 1 mm to 9 mm, and approximately 50 degrees includes all values from 16.6 degrees to 150 degrees.

Lastly, the terms “or” and “and/or,” as used herein, are to be interpreted as inclusive or meaning any one or any combination. Therefore, “A, B, or C” or “A, B, and/or C” mean any of the following: “A,” “B,” or “C”; “A and B”; “A and C”; “B and C”; “A, B and C.” An exception to this definition will occur only when a combination of elements, functions, steps or acts are in some way inherently mutually exclusive.

While the present disclosure has been described with reference to various implementations, it will be understood that these implementations are illustrative and that the scope of the present disclosure is not limited to them. Many variations, modifications, additions, and improvements are possible. More generally, implementations in accordance with the present disclosure have been described in the context of particular implementations. Functionality may be separated or combined differently in various implementations of the disclosure or described with different terminology. These and other variations, modifications, additions, and improvements may fall within the scope of the disclosure as defined in the claims that follow.

1. A method of simulating seismic wave propagation in media, the method implemented by a computer comprising a processor and a memory, the method comprising:
obtaining an earth model having a grid;
modelling, using the earth model, a medium as a set of elastic tensors, wherein respective elastic tensors of the set of elastic tensors have tilted orientations relative to the grid; and
simulating seismic wave propagation in the medium using a wave-equation operator, wherein the wave-equation operator is invariant to orientation changes of the respective elastic tensors of the set of elastic tensors.

2. The method according to claim 1, wherein simulating seismic wave propagation in the medium using the wave-equation operator comprises aligning respective local frames of the wave-equation operator with respective symmetry elements of the respective elastic tensors of the set of elastic tensors.

3. The method according to claim 2, wherein aligning respective local frames of the wave-equation operator with the respective symmetry elements comprises providing the respective local frames by a fiber bundle.

4. The method according to claim 3, wherein providing the respective local frames by the fiber bundle comprises attaching a copy of an orientation grid to respective points in a spatial coordinate grid of the earth model.

5. The method according to claim 3, wherein providing the respective local frames by the fiber bundle comprises representing space of all orientations of respective local frames using respective fibers.

6. The method according to claim 3, wherein providing the respective local frames by the fiber bundle comprises representing the respective local frames axially and complementary to respective fibers.

7. The method according to claim 3, wherein providing the respective local frames by the fiber bundle comprises providing the respective local frames by the fiber bundle having six dimensions;
wherein a base space provides coordinates for location in 3D space; and
wherein respective fibers represent orientation manifolds.

8. The method according to claim 1, wherein the medium has at least one of Tilted Transverse Isotropy (TTI) symmetry, Tilted Orthorhombic (TORT) symmetry, or Tilted Monoclinic symmetry.

9. The method according to claim 1, wherein the earth model is at least one of a heterogeneous model or an anisotropic earth model.

10. The method according to claim 1, further comprising:
outputting a result of simulating the seismic wave propagation in the medium.

11-14. (canceled)

15. A system comprising:
at least one processor; and
a memory including a computer program comprising instructions which, when executed by the at least one processor, cause the system to perform:
provide an earth model having a grid;
model, using the earth model, a medium as a set of elastic tensors, wherein respective elastic tensors of the set of elastic tensors have tilted orientations relative to the grid; and
simulate seismic wave propagation in the medium using a wave-equation operator, wherein the wave-equation operator is invariant to orientation changes of the respective elastic tensors of the set of elastic tensors.

16. The system of claim 15, wherein simulating seismic wave propagation in the medium using the wave-equation operator comprises aligning respective local frames of the wave-equation operator with respective symmetry elements of the respective elastic tensors of the set of elastic tensors.

17. The system of claim 16, wherein aligning respective local frames of the wave-equation operator with the respective symmetry elements comprises providing the respective local frames by a fiber bundle.

18. The system of claim 17, wherein providing the respective local frames by the fiber bundle comprises attaching a copy of an orientation grid to respective points in a spatial coordinate grid of the earth model.

19. The system of claim 15, wherein the computer program comprising further instructions which, when executed by the at least one processor, further cause the system to:
output a result of simulating the seismic wave propagation in the medium.

20. A non-transitory computer readable media storing computer-executable instructions that, when executed by at least one processor, cause a computing device to:
provide an earth model having a grid;
model, using the earth model, a medium as a set of elastic tensors, wherein respective elastic tensors of the set of elastic tensors have tilted orientations relative to the grid; and
simulate seismic wave propagation in the medium using a wave-equation operator, wherein the wave-equation operator is invariant to orientation changes of the respective elastic tensors of the set of elastic tensors.

21. The method of claim 7, wherein the fiber bundle is a generally curved manifold.

22. The method of claim 7, wherein the orientation manifolds are-parameterized by coordinates.

23. The method of claim 7, wherein the orientation manifolds describe respective local orientations of the respective symmetry elements.
